(19) United States
(12) Patent Application Publication
(10) Pub. No.: US 2011/0254258 A1
(43) Pub. Date: Oct. 20, 2011

(54) BOOKMARK FURNISHED WITH AUTOMATIC HOLDING FUNCTION FOR APPLICABLE PAGE

(76) Inventor: Jinwoo Cho, Gyeonggi-do (KR)

(21) Appl. No.: 13/132,825

(22) PCT Filed: Jan. 8, 2009
(86) PCT No.: PCT/KR2009/000090

§ 371 Date: Jul. 5, 2011

(30) Foreign Application Priority Data
Dec. 5, 2008 (KR) 10-2008-0122936

(51) Int. Cl. B42D 9/00

(52) U.S. Cl. 281/42

(57) ABSTRACT

The present invention provides a bookmark furnished with an automatic holding function for an applicable page, wherein after a user has attached a bookmark to a book, a fixed condition is maintained wherein pages do not turn by themselves nor are they turned by external forces including wind, thus not only enabling the current page which the user is reading to be accurately marked but also allowing the user to read subsequent pages continuously without changing the location at which the bookmark has been attached so that the user may use the bookmark in comfort while reading.

### FIELD

The present invention relates, in general, to a bookmark furnished with an automatic holding function for an applicable page and, more particularly, to a bookmark, wherein after a user has attached the bookmark to a book, a fixed condition is maintained wherein pages do not self-turn and are not turned by external forces including wind, thus not only enabling the current page which the user is reading to be accurately marked and but also allowing the user to read subsequent pages continuously without changing the location where the bookmark has been attached, and which is not easily removed or lost from the book.

### BACKGROUND

Generally, when a user cannot finish a book in one sitting due to the many pages of the book or there being an insufficient time for reading, the user may mark a page on which the user has stopped reading so that the page can easily be found at a later time. To mark a page of a book on which the user has stopped reading, the user may fold a corner of the page or may place a bookmark between the pages to mark a place.

Conventional bookmarks have been typically made of a variety of materials, such as metal, plastic, synthetic resin, string and leather, and have various shapes.

However, the conventional bookmarks are problematic in that, to mark a desired page, the user must change the location of the bookmark. Further, when the bookmark is a separate type bookmark, the bookmark may easily be lost when in the state of being attached to a book, thus inconveniencing the user. Further, when the bookmark has a complex structure, the production cost of the bookmark is increased, so that the bookmark may not be produced as an advertising good, such as a good for advertising a company.

### SUMMARY OF THE INVENTION

### Technical Problem

Accordingly, the present invention has been made keeping in mind the above problems occurring in the related art, and is intended to provide a bookmark furnished with an automatic holding function for an applicable page, wherein after a user has attached a bookmark to the book, a fixed condition is maintained wherein pages do not turn by themselves nor are they turned by external forces including wind, thus not only enabling the current page which the user is reading to be accurately marked but also allowing the user to read subsequent pages continuously without changing the location at which the bookmark has been attached so that the user can use the bookmark in comfort while reading.

Further, the present invention serves to provide a bookmark, which is furnished with an automatic holding function for an applicable page, and which can be maintained in a position and be firmly attached to a book, so that the bookmark is less likely to be lost, and which has a simple structure and can be easily produced at low cost.

### Technical Solution

In an aspect, the present invention provides a bookmark furnished with an automatic holding function for an applicable page, comprising: a bookmark body fitted over a right corner of an upper edge of a back cover of a book and comprising an upper cover and a lower cover; and an elastic member held by the lower cover of the bookmark body and fitted over the upper cover, thus holding a page.

In the bookmark, the upper horizontal sides and vertical sides of the upper cover and the lower cover of the bookmark body may be closed, and remaining sides of the upper cover and the lower cover may be formed as inclined open sides which can be fitted over the right corner of the upper edge of the back cover of the book.

Further, the lower cover of the bookmark body may protrude over the upper cover.

Further, opposite sides of a lower end of the lower cover of the bookmark body may be provided with respective locking slits for holding the elastic member, and the elastic member may be made of a rubber string or a rubber band.

Further, the elastic member may be integrally mounted to the bookmark body.

Further, the upper cover and the lower cover of the bookmark body may be provided with a silicone coating on inner surfaces thereof so that the bookmark body can be prevented from slipping over the back cover of the book or from being undesirably removed from the back cover.

Further, the elastic member may be provided with a holder in such a way that the holder can be moved along the elastic member.

### Advantageous Effects

As described above, the bookmark according to the present invention is advantageous in that after a user has attached the bookmark to a book, the fixed condition of the bookmark is maintained so that pages do not turn by themselves nor are they turned by external forces including wind, thus not only enabling the current page which the user is reading to be accurately marked but also allowing the user to read subsequent pages continuously without changing the where location where the bookmark has been attached so that the user can use the bookmark in comfort while reading. Further, the bookmark can be maintained at a position and be firmly attached to the book, so that the bookmark is less likely to become lost. Further, the bookmark has a simple structure and can be easily produced at low cost. Therefore, the present invention remarkably improves the efficiency and operational reliability of the bookmark.

### BRIEF DESCRIPTION OF THE DRAWINGS

FIG. 1 is a perspective view of a bookmark according to the present invention;

FIG. 2 is a perspective view showing the bookmark of the present invention attached to a book;

FIG. 3 is a rear perspective view showing the bookmark of the present invention attached to the book;

FIG. 4 is a front view showing the bookmark of the present invention attached to the book;

FIG. 5 is a perspective view of a bookmark according to another embodiment of the present invention;

FIG. 6 is a perspective view showing the bookmark of FIG. 5 attached to a book; and

FIG. 7 is a front view showing the bookmark of FIG. 5 attached to the book.

### DESCRIPTION OF THE ELEMENTS IN THE DRAWINGS

| | |
|---|---|
| 10; book | 20; back cover |
| 30; bookmark body | 32; upper cover |
| 34; lower cover | 36; locking slit |
| 38; silicone coating | 40; elastic member |
| 50; holder | |

### DETAILED DESCRIPTION OF THE INVENTION

Reference will now be made in greater detail to a preferred embodiment of the invention with reference to the accompanying drawings.

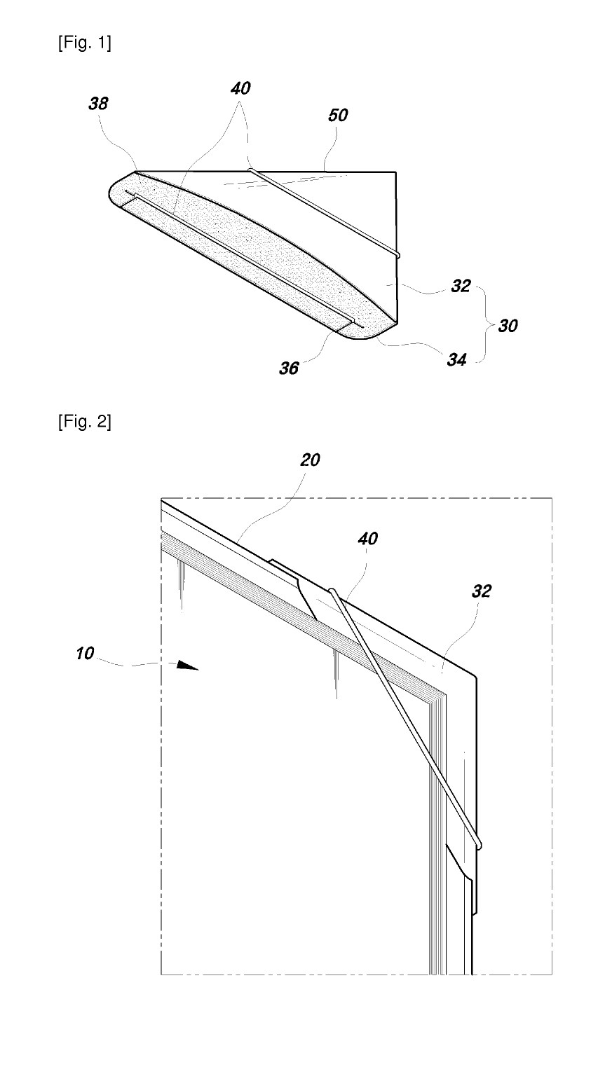

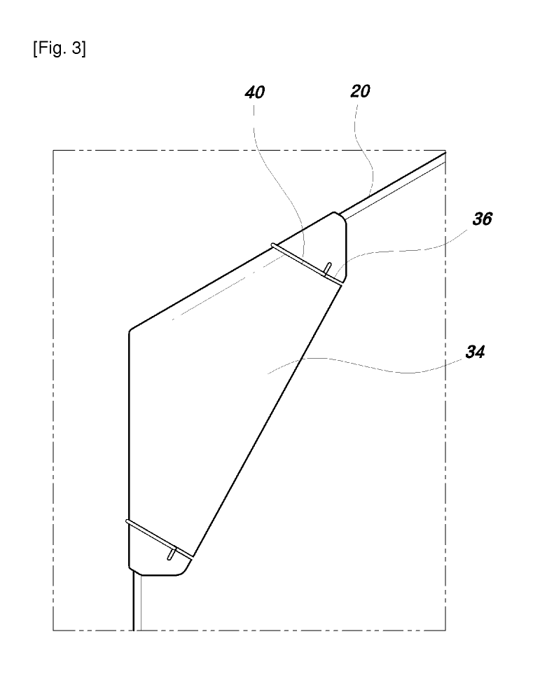

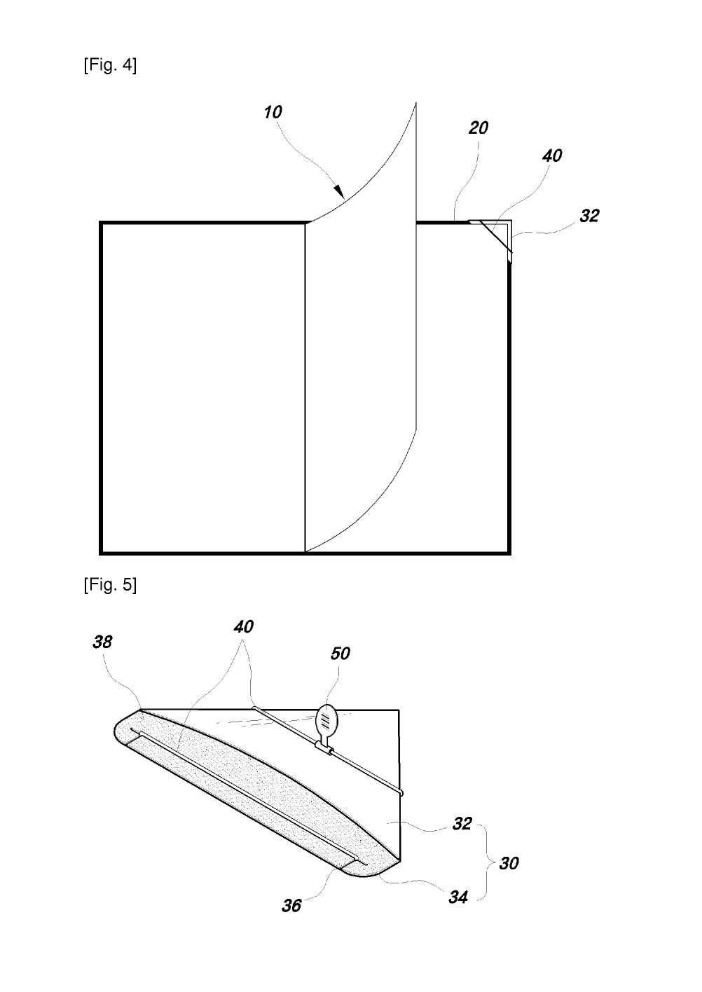

FIG. 1 is a perspective view of a bookmark according to the present invention. FIG. 2 is a perspective view showing the bookmark of the present invention attached to a book. FIG. 3 is a rear perspective view showing the bookmark of the present invention attached to the book. FIG. 4 is a front view showing the bookmark of the present invention attached to the book.

The bookmark furnished with an automatic holding function for an applicable page according to the present invention is used by fitting a bookmark body 30 made of paper, plastic or metal over the right corner of an upper edge of a back cover 20 of a book 10. The bookmark body 30 includes an upper cover 32 and a lower cover 34. The upper horizontal sides and the vertical sides of the upper cover 32 and the lower cover 34 of the bookmark body 30 are closed, while remaining sides of the upper cover 32 and the lower cover 34 are formed as inclined open sides which can be fitted over the right corner of the upper edge of the back cover 20 of the book 10. The lower cover 34 of the bookmark body 30 protrudes over the upper cover 32.

Further, opposite sides of a lower end of the lower cover 34 of the bookmark body 30 are provided with respective locking slits 36. An elastic member 40, made of a rubber string or a rubber band, is held by the locking slits 36 and is elastically fitted over the upper cover 32, thus holding a page. In the present invention, the elastic member 40 may be integrally mounted to the upper cover 32 and the lower cover 34 of the bookmark body 30 using a bonding agent without forming the locking slits 36 in the opposite sides of the lower cover 34.

Further, a silicone coating 38 is formed on the inner surfaces of the upper cover 32 and the lower cover 34 of the bookmark body 30 so as to prevent the bookmark body 30 from slipping over the back cover 20 of the book 10 or from being undesirably removed from the back cover 20 of the book 10.

As shown in FIG. 1 through FIG. 4, when a user wants to attach the bookmark of the present invention to a book 10, the bookmark body 30 is fitted over the right corner of the upper edge of the back cover 20 of the book 10 while opening the inclined open sides of the upper cover 32 and the lower cover 34. Thereafter, the elastic member 40 is pulled using the fingers and is laid on a current page of the book 10, so that the elastic member 40 can be reliably maintained in a state in which it is elastically holding the page of the book 10.

Therefore, when the user turns a page in a state in which the bookmark is attached to the back cover 20 of the book 10, the bookmark can automatically mark the next page and can allow the user to read the following pages continuously without changing its location, so that the user can use the bookmark in comfort while reading.

Further, the bookmark of the present invention can be maintained in a position firmly attached to the book, so that the bookmark is less likely to become lost. Further, the bookmark has a simple structure and can be easily produced at low cost.

Further, in the present invention, the silicone coating 38 is formed on the inner surfaces of the upper cover 32 and the lower cover 34 of the bookmark body 30, so that the bookmark can be effectively prevented from slipping over the back cover 20 of the book 10 and from being undesirably removed from the back cover 20. Further, the bookmark body 30 of the present invention may have a triangular shape, as shown in the drawings, or a rectangular shape, or may be shaped in the form of a metal structure, such as a metal clip. Further, when the bookmark is produced as an advertising good, a company name, a homepage address, etc. may be printed on the rear surface of the lower cover 34 of the bookmark body 30.

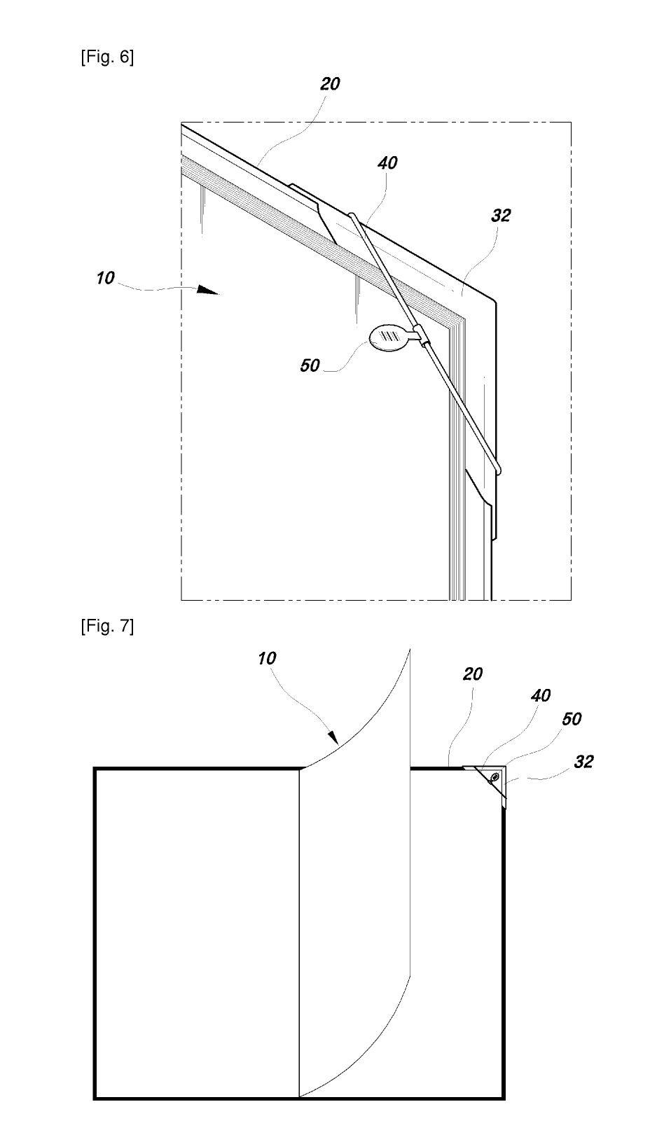

FIG. 5 is a perspective view of a bookmark according to another embodiment of the present invention. As shown in FIG. 5 through FIG. 7, the bookmark of the present invention may be provided with a holder 50 in such a way that the holder 50 can be moved along the elastic member 40. Due to the holder 50, it is easy to hold and pull the elastic member 40 with the fingers when fitting the bookmark body 30 over the book 10. The holder 50 may have a variety of shapes as desired.

1-7. (canceled)

8. A bookmark with an automatic holding function, comprising:
a bookmark body fitted over a right corner of an upper edge of a back cover of a book and the bookmark comprising an upper cover and a lower cover; and
an elastic member held by the lower cover of the bookmark body, wherein the elastic member is fitted over the upper cover.

9. The bookmark of claim 8, wherein upper horizontal sides and vertical sides of the upper cover and the lower cover of the bookmark body are closed, and remaining sides of the upper cover and the lower cover are formed as inclined open sides which can be fitted over the right corner of the upper edge of the back cover of the book.

10. The bookmark of claim 8, wherein the lower cover of the bookmark body protrudes over the upper cover.

11. The bookmark of claim 8, wherein opposite sides of a lower end of the lower cover of the bookmark body are provided with respective locking slits for holding the elastic member, and the elastic member is made of a rubber string or a rubber band.

12. The bookmark of claim 8, wherein the elastic member is integrally mounted to the bookmark body.

13. The bookmark of claim 8, wherein the upper cover and the lower cover of the bookmark body are provided with silicone coating on inner surfaces thereof so that the bookmark body can be prevented from slipping over the back cover of the book or from being undesirably removed from the back cover.

14. The bookmark of claim 8, wherein the elastic member is provided with a holder in such a way that the holder can be moved along the elastic member.
